(19) United States
(12) Patent Application Publication
(10) Pub. No.: US 2024/0361964 A1
(43) Pub. Date: Oct. 31, 2024

(54) NOTIFICATION DISPLAY WITH THUMBNAIL OF PRINT

(71) Applicant: Hewlett-Packard Development Company, L.P., Spring, TX (US)

(72) Inventors: Jeonghun KIM, Seongnam Si (KR); Deokhee BOO, Seongnam Si (KR); Sangmin LEE, Seongnam Si (KR); Woochul SHIN, Seongnam Si (KR); Junyoung CHOI, Seongnam Si (KR)

(21) Appl. No.: 18/687,498

(22) PCT Filed: Feb. 8, 2022
(86) PCT No.: PCT/US2022/015583

§ 371 Date: Feb. 28, 2024

(30) Foreign Application Priority Data
Sep. 2, 2021 (KR) 10-2021-0117187

(51) Int. Cl. G06F 3/12

(52) U.S. Cl. CPC G06F 3/1256; G06F 3/121

(57) ABSTRACT

An example host device includes an input/output device to receive, from a user, a print command for a content, a processor, and a memory to store instructions executable by the processor. By executing the instructions, the processor is to generate a print job corresponding to the content, a thumbnail image corresponding to the print job, and a notification banner including the thumbnail image and information about the print job, and control the input/output device to output the notification banner.

### BACKGROUND

An image forming apparatus may print content (e.g., a document) in response to a print job command received from a host device. The host device may display notification information regarding the print job command. For example, the host device may display, as notification information, a notification banner including a name of a print job being performed by the image forming apparatus.

### BRIEF DESCRIPTION OF THE DRAWINGS

Various examples will be described below by referring to the following figures.

FIG. 1 is a conceptual diagram illustrating a host device to output notification information regarding a document being printed by an image forming apparatus, according to an example.

FIG. 2 is a block diagram illustrating a host device, according to an example.

FIG. 3 is a flowchart illustrating a method of outputting notification information, according to an example.

FIG. 4 is a diagram illustrating a driver and an image forming apparatus management application for a host device to output notification information according to an example.

FIG. 5 is a diagram illustrating a process of outputting notification information, according to an example.

FIG. 6 is a diagram illustrating a process of outputting notification information, according to another example.

FIG. 7 is a diagram illustrating a process of outputting notification information, according to another example.

FIG. 8 is a diagram illustrating a process of outputting notification information, according to another example.

### DETAILED DESCRIPTION

A name of a print job may be generated based on a name of a file to be printed. In a case where a plurality of print jobs are performed for the same or a similar file, a host device may display notification information of a name of an equal or similar print job. Therefore, it may be difficult for a user to precisely recognize which print job an image forming apparatus is performing.

According to an example, a user may recognize information about a print job performed by an image forming apparatus through notification information including a thumbnail image of a document to be output. In that case, the user may cancel a print command through the notification information before the image forming apparatus performs the print job. Thus, resources such as toner, ink, paper, etc. may be saved. The user may recognize, through the notification information, a trouble that may occur while the image forming apparatus performs the print job and control the image forming apparatus.

Hereinafter, examples of the present disclosure are described with reference to the accompanying drawings. However, the present disclosure may be implemented in various different forms and is not limited to the examples described herein.

A “host device” collectively refers to a device capable of transmitting content for an image forming operation to an image forming apparatus The host device may be a personal computer (PC), a smart phone, a tablet, a laptop computer, or the like. The user may execute an application installed in the host device to perform a document operation and execute a print function provided by the application to transmit a document to be printed to the image forming apparatus.

The “image forming apparatus” collectively refers to a device capable of performing an image forming operation, such as a printer, a copier, a scanner, a multifunction printer, a fax machine, and the like. An image forming job may refer to various image-related operations, for example, printing, copying, scanning, faxing, a function related thereto, or a series of processes to perform the image forming job.

A “driver” refers to machine readable instructions that allow an operating system (OS) of the host device to interact with the image forming apparatus. The host device may recognize the image forming apparatus and control the image forming apparatus through the driver. The host device may obtain status information of the image forming apparatus by using the driver. The host device may use the driver to generate print data for a document requested by the user to be printed.

The “status information of the image forming apparatus” refers to information about the status of the image forming apparatus. The status information of the image forming apparatus may include information about an operation status of the image forming apparatus (e.g., standby status, output status, scan status, etc.) and information about a trouble occurring in the image forming apparatus (e.g., paper jam, paper shortage, trouble occurring in a cartridge, etc.). The status information of the image forming apparatus may include information about a page being output by the image forming apparatus. The information about the trouble occurring in the cartridge may include information about a shortage of toner or ink contained in the cartridge. The cartridge refers to a container that contains toner or ink used by the image forming apparatus to print. In order for the user to easily replace the toner or ink, the cartridge may be manufactured as a detachable part of the image forming apparatus.

“Print data” refers to a printing command that depicts an image generated by the host device by using standard functions, in response to a print request from the user. The print data may include page description language (PDL) data in which the host device has encoded the printing command into a description language. The print data may include a printer job language (PJL) related to print settings of the image forming apparatus. The print data may include pixel information of an image (e.g., information indicating whether a pixel corresponds to an image, graphics, or a text). The print data may be transmitted from the host device to the image forming apparatus. The image forming apparatus may generate image information by performing rendering using the print data. The print data may be generated by the driver installed in the host device.

An “image forming apparatus management application” refers to machine readable instructions that output information about an interaction between the host device and the image forming apparatus and provide an interface to receive a user input. The image forming apparatus management application may be machine readable instructions prepared according to the standards of the Universal Windows Platform. The user may use the image forming apparatus management program to change a print setting of the image forming apparatus, check the status of the image forming apparatus, address a trouble occurring in the image forming apparatus, order a consumable of the image forming apparatus, and the like.

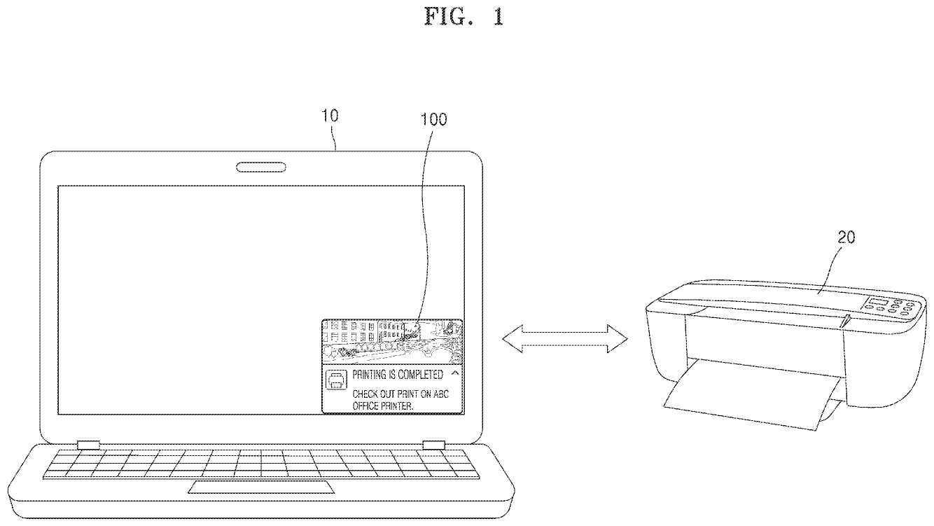

FIG. 1 is a conceptual diagram illustrating a host device to output notification information regarding a document being printed by an image forming apparatus, according to an example.

Referring to FIG. 1, a host device 10 may receive, from a user, a print command for a content. The host device 10 may generate a print job for the content in response to the print command, and may generate print data corresponding to the print job. For example, the host device 10 may use a driver installed in the host device 10 to generate the print job for the content, and may encode the content into the PDL to generate print data. The host device 10 may generate a name of the print job based on a name of a file to be printed.

The host device 10 may transmit/receive data to and from an image forming apparatus 20.

For example, the host device 10 may transmit the print data to the image forming apparatus 20. The print data may include PDL data, PJL data, pixel information of an image, and the like. The image forming apparatus 20 may perform the print job by using the print data. The image forming apparatus 20 may print the content by using the PDL data included in the print data.

As another example, the image forming apparatus 20 may use the driver to transmit status information of the image forming apparatus 20 to the host device 10. For example, the image forming apparatus 20 may transmit, to the host device 10, information about an operation status of the image forming apparatus 20 (e.g., standby status, print status, scan status, etc.) and information about a trouble occurring in the image forming apparatus 20 (e.g., a paper jam, a paper shortage, a trouble occurring in a cartridge, etc.).

The host device 10 may generate notification information including the status information of the image forming apparatus 20. For example, the host device 10 may use an image forming apparatus management application to generate the notification information including the information about the operation status of the image forming apparatus 20 or the information about the trouble occurring in the image forming apparatus 20 (e.g., paper jam, paper shortage, toner shortage, etc.).

The host device 10 may generate the notification information including information about the print job. For example, the host device 10 may generate the notification information including information about a name of the print job and a result of the print job. The host device 10 may display the notification information. For example, the host device 10 may display the notification information using a notification banner 100. The host device 10 may generate the notification banner 100 including the notification information by using a notification template provided by the OS. For example, the host device 10 may generate the notification banner 100 including the notification information according to the notification template in which an upper portion includes an image area and a lower portion includes a message area. The host device 10 may generate the notification banner 100 in which a thumbnail image corresponding to the print job is included in the image area, and the information about the print job (e.g., information about the name of the print job, the result of the print job, etc.) is included in the message area. The host device 10 may display the notification banner 100 on a certain location. For example, the host device 10 may display the notification banner 100 on a lower right corner of a display. The host device 10 may display the notification banner 100 through a pop-up, a toast, and the like.

The host device 10 may use the driver to generate the thumbnail image corresponding to the print job. The thumbnail image corresponding to the print job may be a thumbnail image of a page to be printed by the image forming apparatus 20 or of a page being printed by the image forming apparatus 20. For example, the host device 10 may generate print data of the content by using the driver, in response to the print command for the content received from the user. The host device 10 may generate a bitmap image by rendering the print data using the driver, and may generate a thumbnail image including at least a portion of the bitmap image.

The host device 10 may display the notification banner 100 including at least a portion of the thumbnail image corresponding to the print job. For example, the host device 10 may generate the notification banner 100 including at least a portion of the thumbnail image according to the image area of the notification template provided by the OS. The host device 10 may generate the notification banner 100 by using a thumbnail image stored in a repository. In that case, the thumbnail image may be stored in a repository on a path designated by the image forming apparatus management application. The host device 10 may store the thumbnail image corresponding to the print job along with identification information of the print job in the repository, in response to the print command received from the user. In response to an event related to the identification information of the print job (e.g., a paper jam, a paper shortage, a toner shortage, etc.), the host device 10 may obtain a thumbnail image corresponding to the identification information of the print job from the repository on the designated path. The host device 10 may generate the notification banner 100 including at least a portion of the thumbnail image by using the obtained thumbnail image. The host device 10 may display the notification banner 100 including at least a portion of the thumbnail image on a certain location.

The host device 10 may receive, from the user, an input to control an operation of the image forming apparatus 20 through the notification banner 100.

For example, the host device 10 may use the image forming apparatus management application to generate and display the notification banner 100 including an interface to receive a user input as to whether the image forming apparatus 20 is to perform the print job. The host device 10 may receive the user input through the notification banner 100 and generate control data corresponding to the user input. As an example, the host device 10 may display the notification banner 100 including the interface to receive the user input as to whether the image forming apparatus 20 is to perform the print job along with the information on the print job to be performed by the image forming apparatus 20 and the thumbnail image corresponding to the print job. The host device 10 may receive a user input that authorizes the print job through the interface of the notification banner 100. The host device 10 may transmit the print data for the content to the image forming apparatus 20 in response to the user input that authorizes the print job. Alternatively, the host device 10 may receive a user input that cancels the print job through the interface of the notification banner 100. The host device 10 may delete the print job in response to the user input that cancels the print job.

As another example, the host device 10 may display the notification banner 100 including an interface to receive a user input as to whether the image forming apparatus 20 is to proceed with a print job in which a printing error has occurred, along with information about a printing error (e.g., a paper jam, a paper shortage, a toner shortage, etc.) that has occurred in the image forming apparatus 20 and the thumbnail image of the page being printed by the image forming apparatus 20 at the time of the printing error. The host device 10 may receive the user input that authorizes the print job through the interface of the notification banner 100. In response to the user input that authorizes the print job, the host device 10 may transmit, to the image forming apparatus 20, the control data for printing performed by the image forming apparatus 20 from the page being printed by the image forming apparatus 20 at the time of the printing error. Alternatively, the host device 10 may receive the user input that cancels the print job through the interface of the notification banner 100. The host device 10 may delete the print job in response to the user input that cancels the print job.

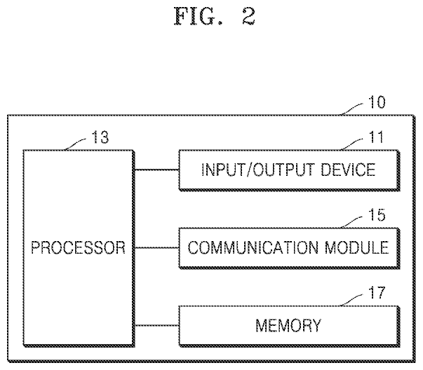

FIG. 2 is a block diagram illustrating a host device, according to an example.

Referring to FIG. 2, the host device 10 may include an input/output device 11, a communication module 15, a memory 17, and a processor 13. However, the host device 10 may be implemented by more components than the components of the host device 10 shown in FIG. 2, and the host device 10 may also be implemented by fewer components than the components of the host device 10 shown in FIG. 2.

The input/output device 11 may include an input device to receive a user input, etc. and an output device to display content to be printed. For example, the input/output device 11 may include a combination of an output device such as a monitor and an input device such as a keyboard, a touchpad, a mouse, a touch screen, and the like.

The host device 10 may transmit/receive data to/from an external device, such as the image forming apparatus 20 and an external server or a network, through the communication module 15. For example, the communication module 15 may transmit print data to the image forming apparatus 20. As another example, the communication module 15 may receive status information of the image forming apparatus 20 from the image forming apparatus 20.

The communication module 15 (e.g., transceiver) may perform wired communication using a standard such as Ethernet, universal serial bus (USB), high definition multimedia interface (HDMI), and the like. The communication module 15 may also perform wireless communication using a standard such as wireless fidelity (Wi-Fi), Wi-Fi direct, Bluetooth, ultra wide band (UWB), near field communication (NFC), and the like.

The memory 17 may store various types of data such as an operating system (OS), programs such as applications, files, and the like. The memory 17 may store at least one instruction and at least one program to process and control the processor 13. The memory 17 may store a driver and an image forming apparatus management application for the image forming apparatus 20.

The memory 17 may include at least one type of storage medium among data storage that temporarily stores data, such as a random access memory (RAM), a static random access memory (SRAM), and data storage that non-temporarily stores data, such as a flash memory type, and a read-only memory (ROM).

The processor 13 may include at least one processing unit such as a central processing unit (CPU) or the like. The processor 13 may also include at least one specialized processing unit corresponding to each function.

By executing the at least one instruction stored in the memory 17, the processor 13 may control the input/output device 11, the communication module 15, the memory 17, and the like to provide examples described with reference to FIGS. 1 and 3 to 8.

The processor 13 may generate a print job such that the image forming apparatus 20 performs an image forming job. For example, the processor 13 may execute instructions stored in the memory 17 to generate a print job and print data from content, in response to a print command from a user for the content input through an application.

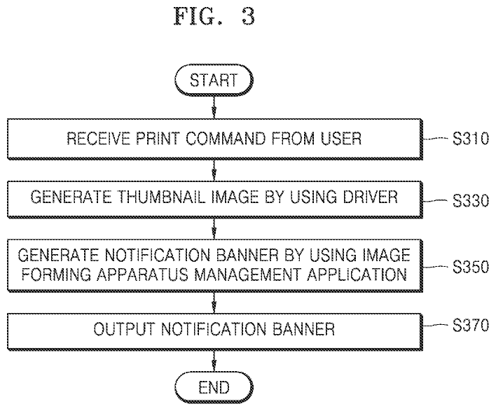

FIG. 3 is a flowchart illustrating a method of outputting notification information, according to an example.

Each operation of FIG. 3 may be implemented by instructions executable by a processor. In addition, the instructions may be stored in a non-transitory computer-readable storage medium including a processor.

Referring to FIG. 3, the host device may receive a print command from a user in operation S310. The host device may receive the print command from the user through an application the user is using. For example, the host device may receive, through a user interface, a print command for content (e.g., a text, an image, etc.) that the user has selected to print.

The host device may generate a print job for the content in response to the print command. For example, the host device may generate the print job by using a name of the content.

In operation S330, the host device may generate a thumbnail image corresponding to the print job, by using a driver. The thumbnail image may be a thumbnail image of a page to be printed by the image forming apparatus 20 or of a page being printed by the image forming apparatus 20. The host device may generate the thumbnail image from print data of the print job.

The host device may generate the print data from content selected by the user. The host device may generate the print data by encoding the content into the PDL using a filter included in the driver. For example, the host device may generate the print data by using an advanced PDL, such as a postscript (PS), a printer command language (PCL), a portable document format (PDF), and the like. As another example, the host device may generate the print data by using a raster-based PDL or a host-based PDL, such as a PCL mobile (PCLm) or a Printer Working Group (PWG) format. The host device may generate print data with a print option by using a filter included in the driver. For example, the host device may generate print data with print options selected by the user (e.g., “paper source”, “color mode”, “scale/resize”, “print mode”, “copy count”, etc.).

The host device may generate, from the print data, the thumbnail image of the page to be printed by the image forming apparatus or of the page being printed by the image forming apparatus. The host device may generate the thumbnail image corresponding to the page being printed by the image forming apparatus by receiving information on the page being printed by the image forming apparatus from the image forming apparatus. The host device may temporarily or non-temporarily store the generated thumbnail image. The host device may update the stored thumbnail image while the image forming apparatus is performing the print job. The host device may generate an image in a bitmap format by rendering the print data. In that case, the host device may generate the image in the bitmap format from the print data with print options. The host device may generate a thumbnail image including at least a portion of the image in the bitmap format. For example, the host device may generate a black-and-white image from print data with a black-and-white option, and may generate a thumbnail image including at least a portion of the black-and-white image. As another example, the host device may generate an image including a plurality of pages from print data with an option regarding the number of pages per sheet, and may generate a thumbnail image including at least a portion of the image including the plurality of pages.

The host device may store the thumbnail image. For example, the host device may store the thumbnail image in a repository on a path designated by an image forming apparatus management application. In that case, the thumbnail image may be stored in the repository along with identification information of the print job. The thumbnail image may be deleted in a case where the print job is removed.

In operation S350, the host device may generate a notification banner including the thumbnail image by using the image forming apparatus management application.

The host device may use the image forming apparatus management application to generate notification information including a message regarding the print job and a thumbnail image corresponding to the print job. For example, the host device may generate notification information including the thumbnail image of the page to be printed by the image forming apparatus or of the page being printed by the image forming apparatus and the identification information of the print job.

The host device may generate notification information in response to a received event related to the image forming apparatus. For example, in response to a received event indicating that a printing error has occurred in the image forming apparatus, the host device may generate notification information including information regarding the printing error (e.g., a paper jam, a paper shortage, etc.) that has occurred in the image forming apparatus and a thumbnail image of a document being printed by the image forming apparatus.

The host device may generate the notification banner by using the notification information. The host device may generate the notification banner by using a notification template provided by the OS. For example, the host device may generate the notification banner including the notification information according to the notification template in which an upper portion includes an image area and a lower portion includes a message area.

The host device may generate the notification banner using the thumbnail image obtained from the repository on the path designated by the image forming apparatus management application. The host device may generate the notification banner by applying information on the path where the thumbnail image is stored to the notification template. For example, the host device may generate the notification banner by using the thumbnail image obtained from the repository on the path designated by the image forming apparatus management application, in response to the received event related to the stored identification information of the print job.

The host device may generate a notification banner including an interface to receive a user input. For example, a notification banner including the interface to receive a user input regarding whether to proceed with the print job along with the information on the print job to be performed by the image forming apparatus and the thumbnail image may be generated. As another example, a notification banner including the interface to receive a user input regarding whether to proceed with a print job in which a printing error has occurred along with the information on the printing error that has occurred in the image forming apparatus and the thumbnail image of the page being printed by the image forming apparatus at the time of the printing error may be generated. The interface of the notification banner may include a button to receive the user input. The interface of the notification banner may also include a selection menu to receive the user input.

In operation S370, the host device may output a notification banner including at least a portion of the thumbnail image.

The host device may output the notification banner including the notification information according to the notification template provided by the OS. For example, the host device may display the notification banner including at least a portion of the thumbnail image on an upper portion and the message related to the print job on a lower portion. The host device may display the notification banner through a pop-up, a toast, and the like.

The host device may display a notification banner that requests a user authorization regarding whether to proceed with the print job. In that case, the notification banner may include the interface to receive a user input regarding whether to proceed with the print job. For example, the notification banner may include a button to receive the user input. As another example, the notification banner may include a selection menu to receive the user input.

The host device may perform an operation corresponding to the user input received through the notification banner. For example, the host device may transmit the print data for the content to the image forming apparatus in response to the user input that authorizes the print job received from the interface. As another example, the host device may delete the print job in response to a user input that cancels the print job received from the interface.

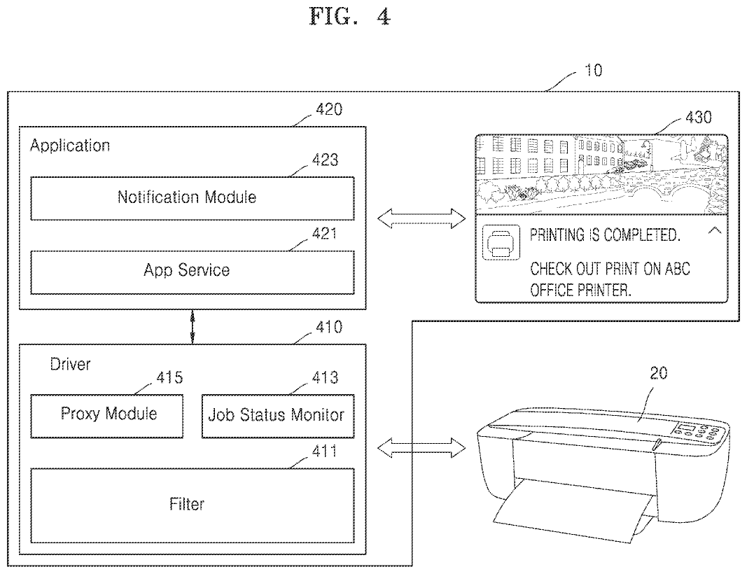

FIG. 4 is a diagram illustrating a driver and an image forming apparatus management application for a host device to output notification information, according to an example.

Referring to FIG. 4, the host device 10 may transmit/receive data to and from the image forming apparatus 20 using a driver 410. In addition, the host device 10 may display notification information through a notification banner 430 generated using an image forming apparatus management application 420.

The driver 410 may include machine readable instructions modules such as a filter 411, a job status monitor 413, and a proxy module 415. However, the driver 410 may be implemented by more components than the components of the driver 410 shown in FIG. 4, and the driver 410 may also be implemented by fewer components than the components of the driver 410 shown in FIG. 4.

The host device 10 may generate a print job in response to a print command for content from a user through an application. The driver 410 may receive information and the content related to the print job.

The driver 410 includes at least one filter 411 to apply certain processing to the content selected by the user to perform the print job. The host device 10 may generate print data by performing certain processing on the content selected by the user by using at least one filter 411. For example, the host device 10 may generate the print data by sequentially applying processing to the content using a watermark filter to process a watermark print option, an overlay filter to process an overlay print option, an N-up filter to process a N-up print option, a poster filter to process a poster print option, a render filter to encode the content into the PDL, such as a printer control language (PCL) or the PS, and the like. The image forming apparatus 20 may perform printing by using the print data output from the filter 411.

The host device 10 may generate a thumbnail image corresponding to the print job by using a thumbnail image filter to generate the thumbnail image. For example, the host device 10 may generate the thumbnail image by using the thumbnail image filter located after a render filter that encodes the content into the PDL. The host device 10 may generate an image in a bitmap format by rendering the print data using the thumbnail image filter. In that case, the host device 10 may generate the image in the bitmap format from the print data with a print option. The host device 10 may generate a thumbnail image including at least a portion of the image in the bitmap format.

The driver 410 may include the job status monitor 413 to receive status information of the image forming apparatus 20 from the image forming apparatus 20 and generate monitoring result data from the status information of the image forming apparatus 20. The host device 10 may identify an operation status of the image forming apparatus 20, a trouble that has occurred in the image forming apparatus 20, and information on a job being performed by the image forming apparatus 20 from the status information of the image forming apparatus 20 received by the job status monitor 413 or the monitoring result data generated by the job status monitor 413.

The driver 410 may include the proxy module 415 to exchange data between the driver 410 and the image forming apparatus management application 420. A notification proxy module to transmit and receive data related to the notification information may be included in the driver 410 apart from the proxy module 415.

The driver 410 may transmit data to the image forming apparatus management application 420 through the proxy module 415. For example, the driver 410 may transmit the monitoring result data generated by the job status monitor 413 to the image forming apparatus management application 420 through the proxy module 415. As another example, the host device 10 may transmit the thumbnail image generated by the filter 411 to the image forming apparatus management application 420 by using the proxy module 415.

The driver 410 may receive data from the image forming apparatus management application 420 through the proxy module 415. For example, the driver 410 may use the proxy module 415 to receive information about a user input received by the image forming apparatus management application 420 through the notification banner 430. As an example, the image forming apparatus management application 420 may receive a user input regarding whether the image forming apparatus 20 is to perform a print job through the notification banner 430. The image forming apparatus management application 420 may transmit, to the proxy module 415, a value of the user input regarding whether to proceed with the print job.

The image forming apparatus management application 420 may include machine readable instructions modules, such as an app service 421 and a notification module 423. However, the image forming apparatus management application 420 may be implemented by more components than the components of the image forming apparatus management application 420 shown in FIG. 4, and the image forming apparatus management application 420 may also be implemented by fewer components than the components of the image forming apparatus management application 420 shown in FIG. 4.

The image forming apparatus management application 420 may include the app service 421 to provide the user with a service related to the image forming apparatus 20. For example, the app service 421 may include an application for the user to use a scan function of the image forming apparatus 20. As another example, the app service 421 may include an application for the user to use a fax function of the image forming apparatus 20. As another example, the app service 421 may include an application for the user to manage a print job being performed by the image forming apparatus 20. As another example, the app service 421 may include an application to generate notification information.

The app service 421 may generate notification information based on data received from the proxy module 415 of the driver 410. For example, the app service 421 may generate notification information regarding a status of the image forming apparatus 20 based on the monitoring result data generated by the job status monitor 413. As another example, the app service 421 may generate notification information regarding a result of the print function performed by the image forming apparatus 20. As another example, the app service 421 may generate notification information regarding a result of the scan function performed by the image forming apparatus 20. As another example, the app service 421 may generate notification information regarding a result of a fax function performed by the image forming apparatus 20.

The app service 421 may generate notification information including the thumbnail image generated by the filter 411. For example, the app service 421 may generate notification information including a thumbnail image of a document to be printed by the image forming apparatus 20 or of a document being printed by the image forming apparatus 20.

The image forming apparatus management application 420 may include the notification module 423 to generate a notification banner to display notification information related to the image forming apparatus 20.

The notification module 423 may generate a notification banner by using the notification information received from the app service 421. For example, the notification module 423 may generate a notification banner including notification information regarding the result of the scan function performed by the image forming apparatus 20. As another example, the notification module 423 may generate a notification banner including notification information regarding the result of the fax function performed by the image forming apparatus 20. As another example, the notification module 423 may generate a notification banner including notification information regarding the result of the print function performed by the image forming apparatus 20. As another example, the notification module 423 may generate a notification banner including notification information regarding the status of the image forming apparatus 20. As an example, the notification module 423 may generate a notification banner including information about an operation status (e.g., a standby status, an output status, a scan status, etc.) of the image forming apparatus 20. The notification module 423 may generate a notification banner including information about a trouble that has occurred in the image forming device (e.g., a paper jam, a paper shortage, a trouble occurring in a cartridge, etc.).

The notification module 423 may generate the notification banner 430 including the notification information by using a notification template provided by the OS. For example, the notification module 423 may generate the notification banner 430 including the notification information according to the notification template in which an upper portion includes an image area and a lower portion includes a message area.

The notification module 423 may generate the notification banner 430 including an interface to receive a user input to control an operation of the image forming apparatus 20. The notification module 423 may receive the user input through the interface of the notification banner 430. For example, the notification module 423 may receive the user input regarding whether the image forming apparatus 20 is to perform a print job through the interface of the notification banner 430. The notification module 423 may transmit the received data regarding the user input to the app service 421.

The notification module 423 may display the notification banner 430 on a certain location. For example, the notification module 423 may display the notification banner 430 on a lower right corner of a display. The notification module 423 may display the notification banner 430 through a pop-up, a toast, and the like.

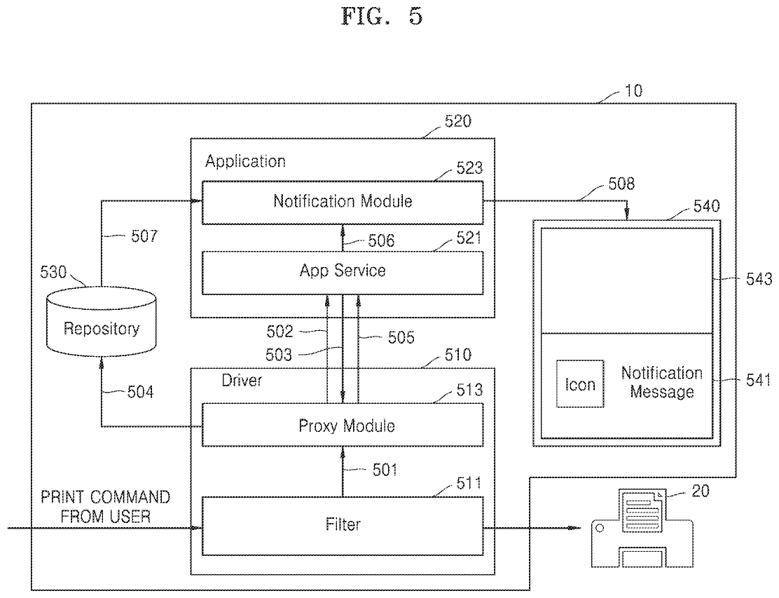

FIG. 5 is a diagram illustrating a process of outputting notification information, according to an example.

Referring to FIG. 5, the host device 10 may receive, from a user, a print command for content through an application. The host device 10 may generate a print job in response to the print command. A filter 511 of a driver 510 may receive the print job and the content.

The host device 10 may generate print data by performing processing on the content using the filter 511. The filter 511 may transmit the print data to the image forming apparatus 20 such that the image forming apparatus 20 performs the print job by using the print data.

The host device 10 may generate a thumbnail image corresponding to the print job from the print data by using the filter 511. For example, the host device 10 may generate a thumbnail image including at least a portion of an image in a bitmap format obtained by rendering the print data by using a thumbnail image filter. The filter 511 may transmit the thumbnail image to a proxy module 513 in operation 501.

The proxy module 513 may request information about a path of a repository 530 in which the thumbnail image is to be stored of an app service 521 of an image forming apparatus management application 520 in operation 502. The app service 521 may transmit, to the proxy module 513, the information about the path of the repository 530, in response to the request from the proxy module 513, in operation 503. The repository 530 may be a storage space included in the image forming apparatus management application 520. The repository 530 may be a storage space to which access is granted by the image forming apparatus management application 520.

The proxy module 513 may store the thumbnail image generated by the filter 511 in the repository 530 based on the information on the path received from the app service 521 in operation 504. The proxy module 513 may transmit, to the app service 521, information about the print job and information about the thumbnail image stored in the repository 530 in operation 505.

The image forming apparatus management application 520 may generate notification information including the thumbnail image generated by the driver 510. For example, the app service 521 may generate notification information including a message regarding the print job and the information on the path where the thumbnail image is stored by using an application that generates the notification information. The app service 521 may transmit the notification information to a notification module 523 in operation 506.

The notification module 523 may generate a notification banner 540 by using the notification information. For example, the notification module 523 may generate the notification banner 540 including notification information regarding a status of the image forming apparatus 20 (e.g., an operation status of the image forming apparatus 20 and a printing error that has occurred in the image forming apparatus 20) generated based on monitoring result data. As another example, the notification module 523 may generate the notification banner 540 including notification information regarding at least result of a scan job, a fax job, and a print job performed by the image forming apparatus 20.

The notification module 523 may generate the notification banner 540 including a thumbnail image. For example, in operation 507, the notification module 523 may obtain a thumbnail image from the repository 530 using the notification information provided by the app service 521 in operation 506. For example, the notification module 523 may generate the notification banner 540 including at least a portion of a thumbnail image (e.g., a thumbnail image of a document to be printed by the image forming apparatus 20, a thumbnail image of a document being printed by the image forming apparatus 20, and the like) corresponding to a print job in an image area 543 of a notification template provided by the OS and information on the print job (e.g., identification information of the print job, information on the printing error that has occurred in the image forming apparatus 20, and the like) in a message area 541.

The notification module 523 may output the generated notification banner 540 in operation 508. For example, the notification module 523 may output the notification information generated according to the notification template to the OS in operation 508. For example, the notification module 523 may output the notification banner 540 including at least a portion of the thumbnail image in the image area 543 and the information about the print job in the message area 541 to the OS in operation 508. The OS may display the notification banner 540 at a certain location on a display. For example, the OS may display the toasted notification banner 540 on a lower right corner of the display.

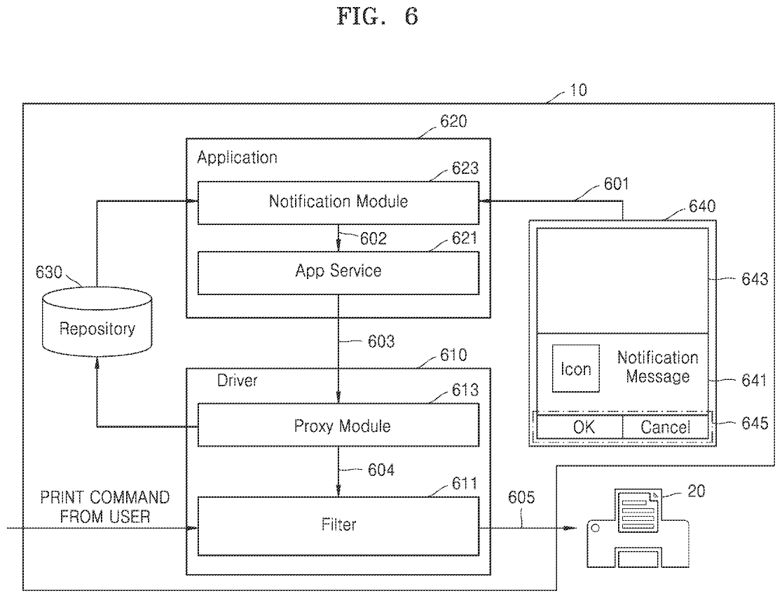

FIG. 6 is a diagram illustrating a process of outputting notification information, according to an example.

The host device 10 may receive, from a user, a print command for content. The host device 10 may generate a print job in response to the print command.

As described above with reference to FIG. 5, the host device 10 may display a notification banner 640 including a thumbnail image corresponding to the print job received from the user. The host device 10 may display information about the print job (e.g., identification information of the print job, information about a printing error that has occurred in the image forming apparatus 20, etc.) on a message area 641 of the notification banner 640. The host device 10 may obtain at least a portion of the thumbnail image corresponding to the print job (e.g., a thumbnail image of a document to be printed by the image forming apparatus 20, a thumbnail image of a document being printed by the image forming apparatus 20, etc.) from a repository 630 to display the same on an image area 643 of the notification banner 640.

Referring to FIG. 6, the host device 10 may display the notification banner 640 including an interface 645 to receive a user input along with the image area 643 and the message area 641. For example, in a case where the host device 10 receives a plurality of print job commands with similar names, the host device 10 may display the notification banner 640 including the interface 645 to receive a user input as to whether the image forming apparatus 20 is to perform the print job.

The interface 645 may display various types of objects to receive the user input. For example, the interface 645 may include a button to receive the user input as to whether to perform the print job. As another example, the interface 645 may include a selection menu to receive the user input as to whether to perform the print job.

An image forming apparatus management application 620 obtains information about the user input. For example, a notification module 623 may obtain, through the interface 645 of the notification banner 640, information about a user input to authorize the image forming apparatus 20 to perform a print job in operation 601. As another example, the notification module 623 may obtain information on a user input to cancel the print job through the interface 645 of the notification banner 640 in operation 601. The notification module 623 may transmit, to an app service 621, the information on the user input received from the notification banner 640 in operation 602.

The image forming apparatus management application 620 may transmit, to a driver 610, the information about the user input received through the interface 645 of the notification banner 640 in operation 603. For example, the app service 621 of the image forming apparatus management application 620 may transmit the information about the user input to a proxy module 613 of the driver 610 in operation 603. As an example, the app service 621 may transmit, to the proxy module 613, the information on the user input to authorize the image forming apparatus 20 to perform the print job in operation 603. Alternatively, the app service 621 may transmit the information on the user input to cancel the print job to the proxy module 613 in operation 603.

The driver 610 may perform an operation corresponding to the user input. For example, a filter 611 of the driver 610 may obtain, from the proxy module 613, the information on the user input received by the interface 645 of the notification banner 640 in operation 604. In response to the user input, the filter 611 may transmit the print job command to the image forming apparatus 20 or delete the print job command received from the user in operation 605. As an example, the filter 611 may transmit print data along with the print job command to the image forming apparatus 20 in response to the user input to authorize the image forming apparatus 20 to perform the print job in operation 605. Alternatively, the filter 611 may delete the print job in response to the user input that cancels the print job.

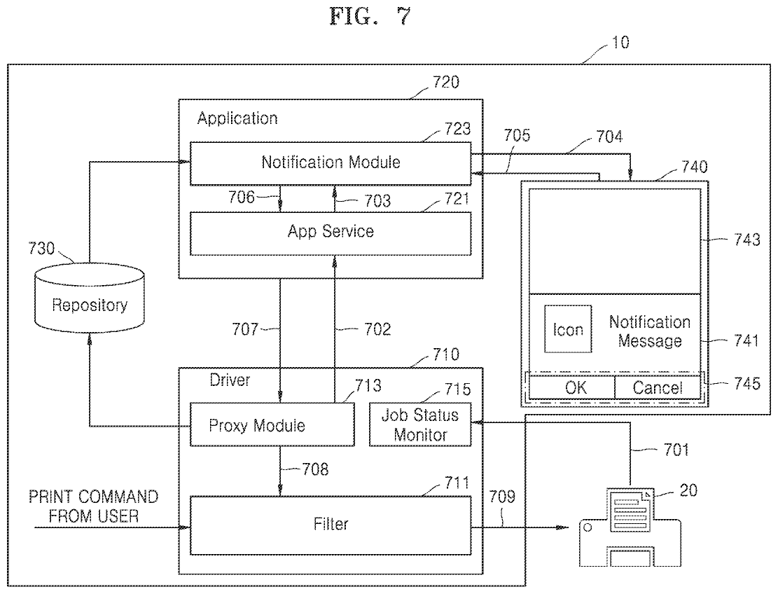

FIG. 7 is a diagram illustrating a process of outputting notification information, according to an example.

The host device 10 may receive, from a user, a print command for content. The host device 10 may generate a print job in response to the print command.

As described above with reference to FIG. 5, the host device 10 may display a notification banner 740 including a thumbnail image corresponding to the print job received from the user. The host device 10 may display, on a message area 741 of the notification banner 740, information about the print job (e.g., identification information of the print job, information about a trouble that has occurred in the image forming apparatus 20, and the like). The host device 10 may obtain, from a repository 730, at least a portion of the thumbnail image corresponding to the print job (e.g., a thumbnail image of a document to be printed by the image forming apparatus 20, a thumbnail image of a document being printed by the image forming apparatus 20, and the like) to display the same on an image area 743 of the notification banner 740.

Referring to FIG. 7, the host device 10 may receive status information of the image forming apparatus 20 from the image forming apparatus 20 in operation 701. For example, the host device 10 may receive, from the image forming apparatus 20, the status information of the image forming apparatus 20, such as information about an operation status of the image forming apparatus 20 (e.g., a standby status, an output status, a scan status, etc.), information about a trouble that has occurred in the image forming apparatus 20 (e.g., a paper jam, a paper shortage, a trouble that has occurred in a cartridge, etc.), and information about a page being printed by the image forming apparatus 20, by using an operation status monitor 715 of a driver 710 in operation 701.

The driver 710 may transmit the received status information of the image forming apparatus 20 to an image forming apparatus management application 720 in operation 702. For example, the driver 710 may transmit, to the image forming apparatus management application 720, the status information of the image forming apparatus 20 indicating that a paper jam has occurred in the image forming apparatus 20 during a print job by using a proxy module 713 in operation 702.

The image forming apparatus management application 720 may generate notification information regarding the status information of the image forming apparatus 20. For example, an app service 721 may generate the notification information regarding the status information of the image forming apparatus received from the proxy module 713. As an example, the app service 721 may generate the notification information indicating that a paper jam has occurred in the image forming apparatus 20 during a print job by using an application to manage the print job of the image forming apparatus 20. The app service 721 may generate notification information regarding a document being printed by the image forming apparatus 20 in which the paper jam has occurred. The app service 721 may transmit the notification information to a notification module 723 in operation 703.

The notification module 723 may generate the notification banner 740 regarding the status information of the image forming apparatus 20 by using the notification information received from the app service 721. For example, the notification module 723 may generate the notification banner 740 including the message area 741 of the notification banner 740 in which a message indicating that a paper jam has occurred in the image forming apparatus 20 during the print job is included, and the image area 743 of the notification banner 740 in which the thumbnail image of the page being printed by the image forming apparatus 20 in which the paper jam has occurred is included.

The notification module 723 may generate the notification banner 740 including an interface 745 to receive a user input along with the image area 743 and the message area 741. For example, the notification module 723 may generate the notification banner 740 including a button through which the interface 745 may receive the user input. As another example, the notification module 723 may generate the notification banner 740 including a selection menu through which the interface 745 may receive the user input.

The notification module 723 may output the generated notification banner 740 in operation 704. For example, the notification module 723 may output notification information generated according to a notification template to the OS in operation 704. The OS may display the notification banner 740 at a certain location on a display. For example, the OS may display the toasted notification banner 740 on a lower right corner of a display.

The OS may display the interface 745 to receive a user input as to whether the paper jam occurring in the image forming apparatus 20 has been resolved. Alternatively, the OS may display the interface 745 to receive a user input as to whether the image forming apparatus 20 is to proceed with the print job.

The image forming apparatus management application 720 obtains information on the user input in operation 705. For example, the notification module 723 may obtain information about a user input to authorize the image forming apparatus 20 to perform the print job through the interface 745 of the notification banner 740. The notification module 723 may obtain information about a user input to cancel the print job through the interface 745 of the notification banner 740. Alternatively, the notification module 723 may obtain information about the user input regarding whether the paper jam occurring in the image forming apparatus 20 has been resolved through the interface 745 of the notification banner 740. The notification module 723 may transmit the information about the user input received from the notification banner 740 to the app service 721 in operation 706.

The image forming apparatus management application 720 may transmit, to the driver 710, the information on the user input received through the interface 745 of the notification banner 740. For example, the app service 721 of the image forming apparatus management application 720 may transmit the information about the user input to the proxy module 713 of the driver 710 in operation 707. As an example, the app service 721 may transmit, to the proxy module 713, the information about the user input to authorize the image forming apparatus 20 to perform the print job. Alternatively, the app service 721 may transmit, to the proxy module 713, the information on the user input to cancel the print job. Alternatively, the app service 721 may transmit, to the proxy module 713, the information about the user input regarding whether the paper jam occurring in the image forming apparatus 20 has been resolved.

The driver 710 may perform an operation corresponding to the user input. For example, a filter 711 of the driver 710 may obtain the information about the user input from the proxy module 713 in operation 708. In response to the user input, the filter 711 may transmit a print job command received from the user to the image forming apparatus 20 in operation 709 or delete the print job command. As an example, the filter 711 may transmit a reprint job command to the image forming apparatus 20 in response to the user input to authorize the image forming apparatus 20 to perform the print job in operation 709. Alternatively, the filter 711 may transmit a command to delete the print job or cancel an interrupted print job, in response to the user input to cancel the print job in operation 709. Alternatively, the filter 711 may transmit the reprint job command to the image forming apparatus 20 in response to a user input indicating that the paper jam occurring in the image forming apparatus 20 has been resolved in operation 709. Alternatively, the filter 711 may transmit a command to delete the print job or cancel the interrupted print job, in response to a user input indicating that the paper jam occurring in the image forming apparatus 20 has not been resolved in operation 709.

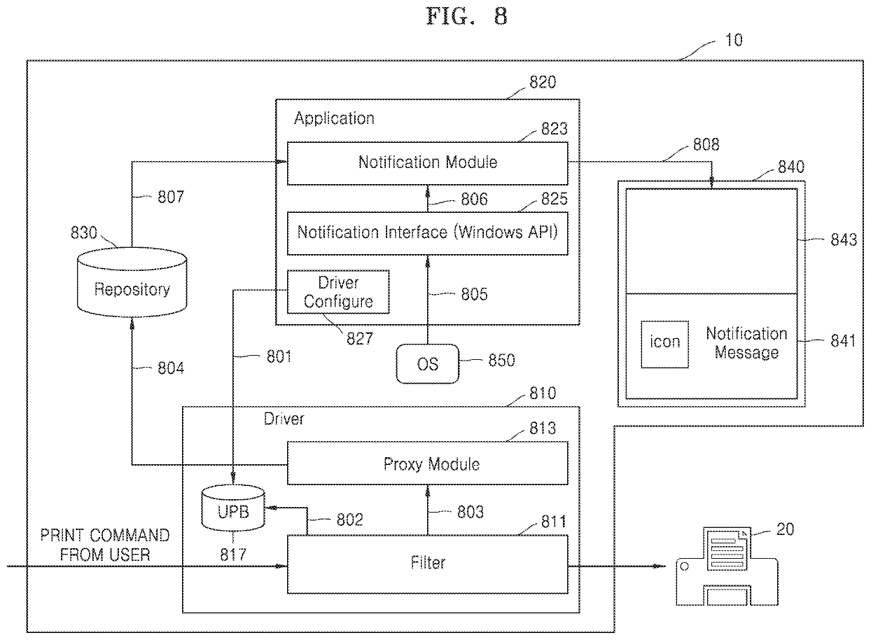

FIG. 8 is a diagram illustrating a process of outputting notification information, according to an example.

Referring to FIG. 8, the host device 10 may detect a path of a repository 830 on which a driver 810 is to store a thumbnail image by using an image forming apparatus management application 820. The image forming apparatus management application 820 may transmit information about the path to the driver 810. For example, a driver configure module 827 of the image forming apparatus management application 820 may transmit the information about the path of the repository 830 on which the driver 810 is to store the thumbnail image to a user property bag (UPB) 817 of the driver 810 in operation 801. The UPB 817 includes a space to store user print settings.

The driver 810 may obtain the information on the path of the repository 830 on which the thumbnail image is stored, in response to a print command from a user. For example, a filter 811 may be connected to the UPB 817 to obtain the information on the path of the repository 830 in operation 802. The filter 811 may obtain the information about the path of the repository 830 from the UPB 817.

The host device 10 may receive, from the user, a print command for content. The host device 10 may generate a print job in response to the print command. The filter 811 of the driver 810 may receive the print job and the content.

The host device 10 may generate print data by performing processing on the content by using the filter 811. The filter 811 may transmit the print data to the image forming apparatus 20 such that the image forming apparatus 20 performs the print job by using the print data.

The host device 10 may generate a thumbnail image corresponding to the print job from the print data by using the filter 811. For example, the host device 10 may obtain an image in a bitmap format and generate a thumbnail image including at least a portion of the image by rendering the print data using a thumbnail image filter. The filter 811 may transmit the thumbnail image to a proxy module 813 in operation 803. Since an example in which the host device 10 generates the thumbnail image from the print data has been described above with reference to FIGS. 3 and 4, redundant descriptions thereof are omitted.

The driver 810 may store the thumbnail image in the repository 830 in operation 804. For example, the proxy module 813 of the driver 810 may receive the thumbnail image generated by the filter 811. The proxy module 813 may store the thumbnail image generated by the filter 811 in the repository 830 based on the information about the path of the repository 830 obtained from the UPB 817 in operation 804. The proxy module 813 may store the thumbnail image corresponding to the print job along with identification information of the print job in the repository, in response to the print command received from the user.

An OS 850 may transmit information about an event generated by the image forming apparatus 20 to the image forming apparatus management application 820 in operation 805. For example, a notification interface 825 of the image forming apparatus management application 820 may receive the information about the event generated by the image forming apparatus 20 from the OS 850. As an example, the notification interface 825 may receive, from the OS 850, information about an event that a paper jam has occurred in the image forming apparatus 20 during a print job. The notification interface 825 may have been built based on an application program interface (API) provided by the OS (e.g., Windows). The notification interface 825 may transmit the information about the event to a notification module 823 in operation 806.

The host device 10 may generate notification information regarding an event generated by the image forming apparatus 20 by using the image forming apparatus management application 820. For example, the notification module 823 may generate notification information indicating that a paper jam has occurred in the image forming apparatus 20 during a print job, based on the information about the event received from the notification interface 825. The notification module 823 may generate notification information regarding a document being printed by the image forming apparatus 20 in which the paper jam has occurred.

The host device 10 may generate a notification banner 840 in response to the event generated by the image forming apparatus 20. The notification module 823 may generate the notification banner 840 including a thumbnail image corresponding to the print job, based on the information about the event received from the notification interface 825. The notification module 823 may obtain the thumbnail image from the repository 830 based on a name of the print job, information on a print page, and a type of the event included in the information on the event in operation 807. For example, the notification module 823 may generate the notification banner 840 regarding the event indicating that the paper jam has occurred in the image forming apparatus 20 during the print job. The notification module 823 may generate the notification banner 840 including an image area 843 of the notification banner 840 in which the thumbnail image of the page being printed by the image forming apparatus 20 in which the paper jam has occurred is included, and a message area 841 of the notification banner 840 in which a message indicating that the paper jam has occurred in the image forming apparatus 20 during the print job is included.

The host device 10 may display the notification banner 840 on a certain location. For example, the host device 10 may display the notification banner 840 on a lower right corner of a display. The host device 10 may display the notification banner 840 through a pop-up, a toast, and the like. The host device 10 may display an interface to receive a user input as to whether the paper jam occurring in the image forming apparatus 20 has been resolved. Alternatively, the host device 10 may display an interface to receive a user input as to whether the image forming apparatus 20 is to proceed with the print job.

Example operation methods as described above may be implemented in the form of a non-transitory computer-readable storage medium that stores instructions or data executable by a computer or processor. The example operation methods described above may be written by a program executable by a computer, and may be implemented by a general-purpose digital computer that operates such a program using a non-transitory computer-readable storage medium. Examples of the non-transitory computer-readable storage media may include read-only memory (ROM), random-access memory (RAM), flash memory, compact disc (CD)-ROMs, CD-recordables (Rs), CD+Rs, CD-rewritables (RWs), CD+RWs, and digital versatile disc (DVD)-ROMs, DVD-Rs, DVD+Rs, DVD-RWs, DVD+RWs, DVD-RAMs, blu-ray disc (BD)-ROMs, BD-Rs, BD-recordable low to highs (R LTHs), BD-REs, magnetic tapes, floppy disks, magneto-optical data storage devices, optical data storage devices, hard disks, solid-state disks (SSDs), and any device capable of storing machine readable instructions, associated data, data files, and data structures, and providing a processor or computer with machine readable instructions, associated data, data files, and data structures such that the processor or computer may execute the instructions.

As described above, although examples have been described with reference to the drawings, various modifications and variations are possible from the above descriptions. For example, the described techniques may be performed in an order different from the described method, and/or the described components of the system, structure, apparatus, circuit, etc. may be combined in a form different from the described example, or other components or components substituted by equivalents may achieve an appropriate result.

It should be understood that examples described herein should be considered in a descriptive sense and not for purposes of limitation. Descriptions of features or aspects within each example should typically be considered as available for other similar features or aspects in other examples. While examples have been described with reference to the figures, it will be understood that various changes in form and details may be made therein without departing from the spirit and scope as defined by the following claims.

What is claimed is:

1. A host device comprising:
an input/output device to receive, from a user, a print command for a content;
a processor; and
a memory to store instructions executable by the processor,
wherein the processor, by executing the instructions, is to:
generate a print job corresponding to the content,
generate a thumbnail image corresponding to the print job,
generate a notification banner including the thumbnail image and information about the print job, and
control the input/output device to output the notification banner.

2. The host device of claim 1, wherein the processor, by executing the instructions, is further to:
control the input/output device to output the notification banner including an interface to receive a user input regarding whether to proceed with the print job, the thumbnail image, and the information about the print job to be performed by an image forming apparatus, and
perform an operation corresponding to the user input received through the interface.

3. The host device of claim 2, wherein the processor, by executing the instructions, is further to:
receive a first input to authorize proceeding of the print job through the interface, and
transmit print data for the content to the image forming apparatus based on the first input.

4. The host device of claim 2, wherein the processor, by executing the instructions, is further to:
receive a second input to cancel the print job through the interface, and
delete the print job based on the second input.

5. The host device of claim 1, wherein the processor, by executing the instructions, is further to:
generate a bitmap image for a page being printed by an image forming apparatus that performs the print job, and
generate a thumbnail image of the page being printed by the image forming apparatus by using the bitmap image.

6. The host device of claim 5, wherein the processor, by executing the instructions, is further to:
obtain information about a print error that has occurred in the image forming apparatus, and
generate the notification banner including the thumbnail image of the page being printed by the image forming apparatus at a time of the print error and the information about the print error.

7. The host device of claim 6, wherein the processor, by executing the instructions, is further to:
control the input/output device to output the notification banner including an interface to receive a user input as to whether to proceed with the print job in which the print error has occurred, and
perform an operation corresponding to the user input, received through the interface, as to whether to proceed with the print job.

8. The hose device of claim 1, wherein the processor, by executing the instructions, is further to:
store the thumbnail image in a repository designated by an image forming apparatus management application, and
generate the notification banner by using the thumbnail image stored in the repository.

9. The host device of claim 8, wherein the processor, by executing the instructions, is further to:
store the thumbnail image along with identification information of the print job in the repository,
obtain the thumbnail image from the repository, based on the identification information of the print job, in response to an event related to the identification information of the print job, and
generate the notification banner by using the obtained thumbnail image.

10. A non-transitory computer-readable storage medium storing instructions executable by a processor of a computer, the non-transitory computer-readable storage medium comprising:
instructions to receive, from a user, a print command for a content;
instructions to generate a print job corresponding to the content;
instructions to generate a thumbnail image corresponding to the print job;
instructions to generate a notification banner including the thumbnail image and information about the print job, and
instructions to output the notification banner.

11. A method, performed by a host device, of outputting a notification banner, the method comprising:
receiving a print command for a content from a user;
generating a print job corresponding to the content;
generating a thumbnail image corresponding to the print job;
generating a notification banner including the thumbnail image and information about the print job; and
outputting the notification banner.

12. The method of claim 11,
wherein the generating of the notification banner comprises generating a notification banner including an interface to receive a user input regarding whether to perform the print job, the thumbnail image, and information about the print job to be performed by an image forming apparatus,
wherein the outputting of the notification banner comprises outputting a notification banner including the interface, and
wherein the method further comprises performing an operation corresponding to the user input received through the interface.

13. The method of claim 11, wherein the generating of the thumbnail image comprises:
generating a bitmap image for a page being printed by an image forming apparatus that performs the print job; and
generating a thumbnail image of the page being printed by the image forming apparatus by using the bitmap image.

14. The method of claim 13, wherein the generating of the notification banner comprises:
obtaining information about a print error that has occurred in the image forming apparatus; and
generating a notification banner including the thumbnail image of the page being printed by the image forming apparatus at a time of the print error and the information about the print error.

15. The method of claim 11, wherein the generating of the notification banner further comprises:
storing the thumbnail image on a path designated by an image forming apparatus management application; and
generating the notification banner by using the thumbnail image stored on the designated path.
